(19) United States
(12) Patent Application Publication
(10) Pub. No.: US 2016/0327262 A1
(43) Pub. Date: Nov. 10, 2016

(54) CLIP-ON CANDLER HOLDER

(71) Applicant: Cohen Michael Harris, Coconut Creek, FL (US)

(72) Inventor: Cohen Michael Harris, Coconut Creek, FL (US)

(21) Appl. No.: 15/093,926

(22) Filed: Apr. 8, 2016

Related U.S. Application Data
(60) Provisional application No. 62/158,048, filed on May 7, 2015.

(51) Int. Cl. F21V 35/00; A47G 19/22; F16M 13/02

(52) U.S. Cl. CPC F21V 35/00; F16M 13/022; A47G 19/2227

(57) ABSTRACT

A holder is configured to retain a conventional birthday candle in a generally upright orientation on a drinking glass. In various embodiments, the holder has opposing leg portions that bias together to capture between them the exposed edge of a drinking glass wall.

### BACKGROUND OF THE INVENTION

The present invention is in the technical field of candle holders. Herein, the term “birthday candle” refers specifically to relatively small candles having a length no greater than about three inches and a nominal diameter dimension no greater than about ⅜ inch (0.37 inches). A birthday candle is defined both by size and application as they are intended for use specifically by placing in on food items and the like. Current means of using birthday candles are generally limited to placements on food or dessert items. There are no current methods or devices for fixing birthday candles to various objects such as drinking glasses for similar use.

### BRIEF SUMMARY OF THE INVENTION

The present invention is a method and device for holding and securing candles to the top wall edge of drink ware such as glasses. The invention includes a rigid holder having leg or finger elements that capture, between them, the exposed upper edge of a drink ware and provides a receptacle for securing a birthday candle. The invention includes a novel combination of a holder and a conventional birthday candle. In combination with a conventional drinking glass, the invention includes a method and device to support a conventional birthday candle.

### BRIEF DESCRIPTION OF THE DRAWINGS

A clear understanding of the features of the invention summarized above may be had by referring to the appended drawings. These illustrate the construction and method of use example configurations of the invention. Although the drawings depict the preferred embodiment of the invention, they are not to be considered as limiting its scope with regard to other embodiments which the invention is capable of.

FIG. 1 is an isometric view of a clip-on candle holder formed in accordance with one embodiment of the present invention.

FIG. 2 is a side view of the present invention of FIG. 1.

FIG. 3 is an isometric view of the present invention of FIG. 1.

FIG. 4 is an isometric view of the present invention of FIGS. 1 to 3 assembled with a candle and a supporting object.

FIG. 5 is an isometric view of an alternative configuration of a clip-on candle holder formed in accordance with one embodiment of the present invention.

FIG. 6 is an isometric view of a clip-on candle holder variation formed in accordance with one embodiment of the present invention.

### DETAILED DESCRIPTION OF THE INVENTION

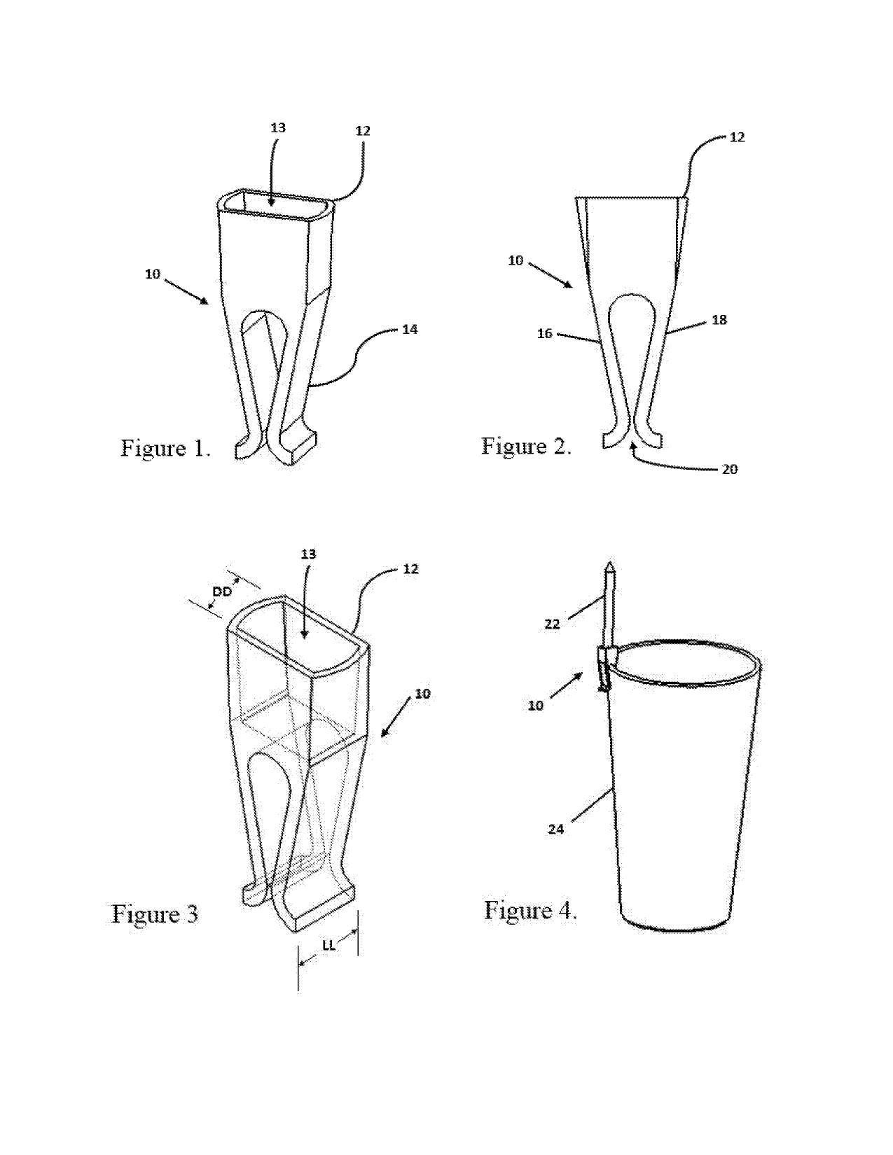

Referring now to the invention in more detail, FIGS. 1 to 4, show a clip-on candle holder 10 consisting of a candle receiving end 12 including a candle receptacle cavity 13 and a support end 14 for retaining the holder onto a supporting object 24. Ideally, the candle receptacle cavity 13 is sized to have a width or nominal diameter dimension DD sufficiently small enough to fit and fix a conventional birthday candle 22. The receiving end 12 and cavity 13 are configured to receive one end of the candle to retain the candle in an upright vertical orientation. Conventional birthday candles have a diameter in the range of 0.15 inch to 0.25 inch (3.8 to 6.3 millimeters). A useful width or diameter dimension DD should be slight less that this range. The other end of holder 10 is configured to clip to a supporting object with enough force to remain at a fixed position. Although a preferred embodiment for the present invention 10 is shown in FIGS. 1 to 4, it is to be understood that other shapes and configurations may be used.

Referring now to the present invention of FIGS. 2 and 3, the holder 10 support end includes two legs 16, 18 which extend opposite the candle-receiving end 12 and converge to a gap 20. The legs 16, 18 are configured to clip onto a drink glass wall such that the gap 20 will get larger and the legs 16, 18 will induce a clamping force onto the object. This is one method of fixation onto the supporting object however the present invention may include other methods including adhesion and the like. The present invention may also combine different leg shapes, leg angles, or leg materials to achieve the desired fitment.

The candle can be moved to different positions and fixed. These positions include, but are not limited to, changes in positions along the horizontal axis, vertical axis, and angles about an axis of rotation. This allows for a large range of fixed candle positions and thus it is useful for supporting objects at various angles.

In more detail, now referring to FIG. 4, an assembly of the present inventive holder 10 is shown combined with a conventional birthday candle 22 supported on a supporting object 24, in this configuration a drinking grass. Also note that the supporting object 24 has an outward angle from its base to the holder 10, thus the candle being held has been fixed at an inward angle within the holder 10. This is one of many supporting object possibilities.

Due to the circular geometry of a drinking glass, if the supporting end 14 or legs 16, 18 are rigid and linear, and their inward biasing force is large, local bending forces will be applied to the drinking glass wall. This risks breaking the drinking glass wall. For this reason, a maximum width dimension LL, perpendicular the gap 20 (approximately parallel the drink glass wall) is preferably less than 0.35 inch (8.9 millimeters). Dimensions greater than this risk glass breakage and are not suggested.

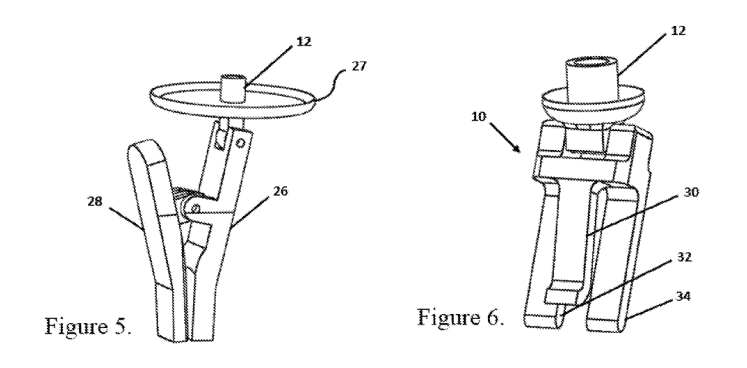

Now referring to FIG. 5, a modified form of the present invention is presented to display a configuration of the device in multiple pieces. The form shown has three pieces, two of which are legs. The legs 26, 28 rotate about a connection point and are loaded with force by a spring. The third piece is the receiving end 12 which supports a candle in the manner discussed, and can then be rotated about an axis on the leg 26. Note this receiving end has a wax catching disk 27 directly underneath a candle. This helps to describe the present invention's variations in possible materials and methods for attachment to supporting objects, and configurations for added functionality.

Now referring to FIG. 6, a modified form of the present invention is presented to display a leg configuration consisting of more than two legs. The three legs 30, 32, 34 are spaced, and alternatively opposing, such that it may also sit fixed onto a supporting object of various shape. The receiving end 12 supports a candle and rotates it about an axis on the holder 10.

Various materials may be used to construct the present invention including, but not limited to, uniform materials such as polylactic acid (PLA) plastic, acrylonitrile butadiene styrene (ABS) plastic, or any other sufficiently rigid, strong, and flexible material such as wood, glass of a suitable thickness, metal, steel, aluminum, iron, various other metal alloys, and the like. In addition, a combination of the various materials to create the present invention may also be used for its construction.

The advantages of the present invention include, without limitation, being able to clip onto supporting objects of various thickness, curvature, and angles while remaining clamped with a sufficient force to hold a candle in a multitude of positions and angles. Other advantages to the present invention include being lighter in weight by using only two legs, and being flexible enough to expand and not fracture while retaining the clamping force.

In broad definition, the present invention is a holder for conventional birthday candles that clips onto supporting objects. While the foregoing written description of the invention enables one of ordinary skill to make and use what is considered presently to be the best mode thereof, those of ordinary skill will understand and appreciate the existence of variations, combinations and equivalents of the specific embodiment, method, and examples herein. The invention should therefore not be limited by the above described embodiment, method, and examples, but by all embodiments and methods within the scope and spirit of the invention.

I claim:

1. A holder for a conventional birthday candle comprising:
a support configured to retain a conventional birthday candle;
a securing means for retaining the support to the upper wall edge of a drinking glass.

2. A holder, according to claim 1, wherein:
the support includes a cavity configured to receive and retain a conventional birthday candle.

3. A holder, according to claim 2 and wherein:
the cavity has a width dimension in the range to 0.15 to 0.25 inches.

4. A holder, according to claim 1, and wherein:
the securing means comprises two opposing legs, the legs biased together.

5. A holder, according to claim 2, and further comprising:
a candle disposed within the cavity.

6. A holder, according to claim 5, and further comprising:
a drinking grass, the support being retained on a upper wall edge of the drinking glass.
